(19) United States
(12) Patent Application Publication
(10) Pub. No.: US 2026/0112642 A1
(43) Pub. Date: Apr. 23, 2026

(54) NEGATIVE ELECTRODE AND METAL BATTERY

(71) Applicant: Industrial Technology Research Institute, Hsinchu (TW)

(72) Inventors: Wei-Hsin Wu, Hsinchu City (TW); Yin-Cheng Yen, Hsinchu City (TW); Yi-Jen Wang, New Taipei City (TW); Deng-Tswen Shieh, Hsinchu City (TW)

(73) Assignee: Industrial Technology Research Institute, Hsinchu (TW)

(21) Appl. No.: 19/198,155

(22) Filed: May 5, 2025

Related U.S. Application Data
(60) Provisional application No. 63/710,602, filed on Oct. 23, 2024.

(30) Foreign Application Priority Data
Dec. 30, 2024 (TW) 113151584

(51) Int. Cl. H01M 4/62; H01M 4/134; H01M 4/36; H01M 4/38

(52) U.S. Cl. CPC H01M 4/628; H01M 4/134; H01M 4/366; H01M 4/382

(57) ABSTRACT

A negative electrode and a metal battery are provided. The negative electrode includes a substrate and a protective layer. The protective layer is disposed over the substrate, and includes an amorphous inorganic compound layer and a plurality of crystalline lithium oxide particles. The crystalline lithium oxide particles are dispersed in the amorphous inorganic compound layer.

### CROSS-REFERENCE TO RELATED APPLICATION

The present application is based on, and claims priority from, U.S. Provisional Application Ser. No. 63/710,602, filed on Oct. 23, 2024, and Taiwan Application Serial Number 113151584, filed on Dec. 30, 2024, the disclosure of which is hereby incorporated by reference herein in its entirety.

### TECHNICAL FIELD

The present disclosure relates to a negative electrode and a metal battery.

### BACKGROUND

Lithium batteries have become the mainstream of commercial batteries and can be used in a variety of fields, including electric vehicles. In conventional lithium batteries, when lithium metal is used as the negative electrode, lithium metal corrosion is likely to occur on the solid electrolyte interface (SEI) formed at the interface between lithium metal and electrolyte after multiple charge and discharge cycles, which affects the cycle life and stability of the batteries. Therefore, there is still a need to provide lithium batteries including a solid electrolyte interface with corrosion resistance for industry selection.

### SUMMARY

A negative electrode of the disclosure includes a substrate and a protective layer. The protective layer is disposed on the substrate and includes an amorphous inorganic compound layer and a plurality of crystalline lithium oxide particles. The plurality of crystalline lithium oxide particles are dispersed in the amorphous inorganic compound layer.

A metal battery of the disclosure comprises a positive electrode, a separator, the negative electrode as described above, and a liquid electrolyte. The negative electrode and the positive electrode are separated by the separator. The liquid electrolyte is disposed between the positive electrode and the negative electrode.

Several exemplary embodiments accompanied with figures are described in detail below to further describe the disclosure in details.

### BRIEF DESCRIPTION OF THE DRAWINGS

The accompanying drawings are included to provide a further understanding, and are incorporated in and constitute a part of this specification. The drawings illustrate exemplary embodiments and, together with the description, serve to explain the principles of the disclosure.

FIG. 1 is a schematic diagram of a negative electrode according to an embodiment of the present disclosure.

FIG. 2 is a schematic diagram of a negative electrode according to another embodiment of the present disclosure.

FIG. 3 is a schematic diagram of a metal battery according to an embodiment of the present disclosure.

FIG. 4 is a transmission electron microscope (TEM) image of the protective layer of Example 1.

FIG. 5 is a TEM image of the protective layer of Example 2.

FIG. 6 is a TEM image of the protective layer of Comparative Example 1.

FIG. 7 is a TEM image of the protective layer of Comparative Example 2.

### DETAILED DESCRIPTION OF THE EMBODIMENTS

The disclosure may be understood by referring to the following detailed description and in collaboration with the accompanying drawings. It should be noted that, in order to make the readers easy to understand and for the concise of the drawings, the multiple drawings in the disclosure only draw a part of an electronic device, and certain elements in the drawings are not drawn to actual scales. In addition, the number and size of each component in the figures are only for illustration, and are not intended to limit the scope of the disclosure.

Directional terminology mentioned in the following embodiments, such as “top,” “bottom,” etc., is used with reference to the orientation of the FIG(s) being described and are not intended to limit the disclosure. In the FIGs, each of the drawings depicts typical features of methods, structures, and/or materials used in the particular exemplary embodiments. However, these drawings are not to be interpreted as limiting or limiting the scope or property covered by these exemplary embodiments. For example, for clarity, relative thickness and position of each film layer, region and/or structure may be reduced or enlarged.

When a corresponding component (for example, a film layer or an area) referred to be “on another component”, the component may be directly located on the another component, or other components probably exist there between. On the other hand, when a component is referred to be “directly on another component”, none other component exits there between. Moreover, when a component is referred to be “on another component”, the two components have an up-down relationship in a top view, and this component may be above or below another component, and the up-down relationship depends on an orientation of the device.

The terms “about”, “equal to”, “equivalent” or “identical”, “substantially” or “approximately” are generally interpreted as being within a range of 20% of a given value or range, or as being within a range of 10%, 5%, 3%, 2%, 1%, or 0.5% of the given value or range.

It should be noted that, in the following embodiments, the features of several different embodiments may be replaced, reorganized, and mixed to complete other embodiments without departing from the spirit of the disclosure. As long as the features of the various embodiments do not violate the spirit of the disclosure or conflict with each other, they may be mixed and matched arbitrarily.

In order to provide a negative electrode having both good electrolyte corrosion resistance and good lithium utilization rate, the present disclosure proposes a negative electrode that can achieve the above advantages. In the following, specific embodiments are described as examples according to which the present disclosure can surely be implemented.

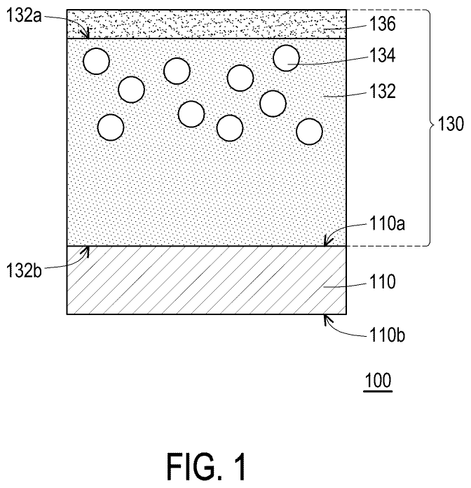

FIG. 1 is a schematic diagram of a negative electrode according to an embodiment of the present disclosure. Referring to FIG. 1, a negative electrode 100 includes a substrate 110 and a protective layer 130. In one embodiment, the negative electrode 100 is a negative electrode for a metal battery.

In one embodiment, the substrate 110 is a current-collecting substrate. According to one embodiment of the present disclosure, the substrate 110 may include a metal foil. For example, the material of the substrate 110 may be aluminum, copper, nickel, aluminum-containing alloy, copper-containing alloy, nickel-containing alloy, stainless steel, or a combination thereof. According to one embodiment of the present disclosure, the aluminum-containing alloy is distinct from the copper-containing alloy, the nickel-containing alloy, or the stainless steel. According to one embodiment of the present disclosure, the copper-containing alloy is distinct from the aluminum-containing alloy, the nickel-containing alloy, or the stainless steel. According to one embodiment of the present disclosure, the nickel-containing alloy is distinct from the aluminum-containing alloy, the copper-containing alloy, or the stainless steel. According to one embodiment of the present disclosure, the stainless steel is distinct from the aluminum-containing alloy, the nickel-containing alloy, or the copper-containing alloy. The thickness of the substrate 110 is not limited and may be adjusted according to actual needs, and may be, for example, between 5 μm and 500 μm.

In one embodiment, the protective layer 130 is a solid electrolyte interface (SEI). That is, the protective layer 130 is a film layer formed after the liquid electrolyte in the metal battery including the negative electrode 100 is decomposed. In one embodiment, the protective layer 130 is disposed on the substrate 110. Specifically, as shown in FIG. 1, the substrate 110 has a top surface 110a and a bottom surface 110b opposite to each other, and the protective layer 130 is disposed on the top surface 110a. In one embodiment, the thickness of the protective layer 130 is greater than about 10 nm. For example, the thickness of the protective layer 130 may be about 20 nm to about 500 nm, such as about 20 nm to about 400 nm, 20 nm to about 300 nm, or 20 nm to about 200 nm. Referring to FIG. 1, the protective layer 130 includes an amorphous inorganic compound layer 132 and a plurality of crystalline lithium oxide particles 134. In addition, in one embodiment, the protective layer 130 may further include an organic compound layer 136.

In one embodiment, the amorphous inorganic compound layer 132 is directly on the substrate 110. Specifically, as shown in FIG. 1, the amorphous inorganic compound layer 132 has a top surface 132a and a bottom surface 132b opposite to each other, and the bottom surface 132b of the amorphous inorganic compound layer 132 is in direct contact with the top surface 110a of the substrate 110. In one embodiment, the amorphous inorganic compound layer 132 includes lithium oxide accounting for 90 wt % or more of the total weight of the amorphous inorganic compound layer 132. That is, the material of the amorphous inorganic compound layer 132 mainly includes amorphous lithium oxide. From another perspective, the product components after decomposition of the liquid electrolyte in the metal battery including the negative electrode 100 mainly include lithium oxide.

In one embodiment, the plurality of crystalline lithium oxide particles 134 are dispersed in the amorphous inorganic compound layer 132. Specifically, as shown in FIG. 1, the plurality of crystalline lithium oxide particles 134 are dispersed at a side of the amorphous inorganic compound layer 132 away from the substrate 110. From another point of view, compared to the bottom surface 132b of the amorphous inorganic compound layer 132, the plurality of crystalline lithium oxide particles 134 dispersed in the amorphous inorganic compound layer 132 are adjacent to the top surface 132a of the amorphous inorganic compound layer 132. In one embodiment, the particle size of the crystalline lithium oxide particles 134 may be about 1 nm to about 100 nm, for example, about 1 nm to about 80 nm, about 1 nm to about 60 nm, or about 1 nm to about 40 nm. In one embodiment, the particle size of each crystalline lithium oxide particle 134 is about 1 nm to about 100 nm. In one embodiment, the crystalline lithium oxide particle 134 may have a crystal plane (111), a crystal plane (220), a crystal plane (311), a crystal plane (400), a crystal plane (422), a crystal plane (440), or a combination thereof. In one embodiment, each crystalline lithium oxide particle 134 has a crystal plane (111), a crystal plane (220), a crystal plane (311), a crystal plane (400), a crystal plane (422), or a crystal plane (440). In one embodiment, each of the crystalline lithium oxide particles 134 has different crystal plane combinations. That is, the crystalline lithium oxide particles 134 may be polycrystalline lithium oxide particles. In one embodiment, the content of the crystalline lithium oxide particles in the amorphous inorganic compound layer may be at least about 0.1 wt %, for example, about 0.1 wt % to about 10 wt %, based on the total weight of the amorphous inorganic compound layer.

In one embodiment, the protective layer may further include an organic compound layer. In one embodiment, the organic compound layer 136 is disposed on the amorphous inorganic compound layer 132. Specifically, as shown in FIG. 1, the organic compound layer 136 is directly contact the top surface 132a of the amorphous inorganic compound layer 132. In one embodiment, the organic compound layer 136 includes an oligomer. In detail, the oligomer may be a derivative obtained by decomposition of a solvent in a liquid electrolyte in a metal battery including the negative electrode 100. For example, when the liquid electrolyte solvent includes dimethyl ether (DME), the organic compound layer 136 may include polyethylene glycol oligomers derived from the decomposition and polycondensation of dimethyl ether.

It is worth noting that the protective layer 130 includes the amorphous inorganic compound layer 132 and the plurality of crystalline lithium oxide particles 134 dispersed in the amorphous inorganic compound layer 132, and thus the negative electrode 100 can have both good electrolyte corrosion resistance and good lithium utilization rate, so that the metal battery including the negative electrode 100 has good battery cycle life, capacity and stability. In addition, the protective layer 130 includes the organic compound layer 136, so that the protective layer 130 has a considerable degree of mechanical strength.

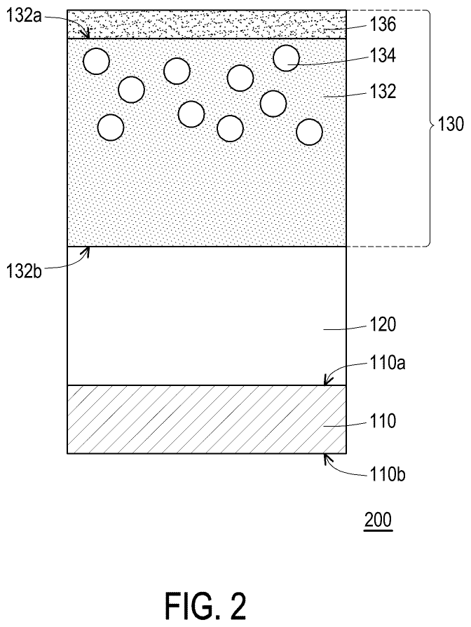

FIG. 2 is a schematic diagram of a negative electrode according to another embodiment of the present disclosure. Please refer to FIG. 2 and FIG. 1, the negative electrode 200 of FIG. 2 is similar to the negative electrode 100 of FIG. 1, and therefore the same or similar elements are represented by the same or similar numerals, and the related descriptions thereof may refer to the descriptions above and are thus omitted here. Hereinafter, the difference between the two embodiments will be described.

According to one embodiment of the present disclosure, the negative electrode may be further configured with an active material layer. In one embodiment, referring to FIG. 2, the negative electrode 200 includes an active material layer 120 disposed between the substrate 110 and the protective layer 130. Specifically, in one embodiment, the active material layer 120 is in direct contact with the top surface 110a of the substrate 110 and in direct contact with the bottom surface 132b of the amorphous inorganic compound layer 132 in the protective layer 130. From another point of view, the active material layer 120 is directly on the top surface 110a of the substrate 110 and directly on the bottom surface 132b of the amorphous inorganic compound layer 132.

According to one embodiment of the present disclosure, the active material layer 120 includes lithium metal, a lithium-containing alloy, or a combination thereof. In addition, according to one embodiment of the present disclosure, the thickness of the active material layer 120 is not particularly limited, and a person skilled in the art may adjust the thickness according to actual needs. For example, the thickness of the active material layer 120 may be about 1 μm to about 1,000 μm (e.g., about 10 μm, 50 μm, 100 μm, 200 μm, 300 μm, 400 μm, 500 μm, 600 μm, 700 μm, 800 μm, or 900 μm).

The present disclosure also provides a metal battery, which uses any one negative electrode provided in the above embodiments (such as the negative electrode 100 or negative electrode 200), therefore, the related descriptions of the negative electrode 100 and the negative electrode 200 in the following embodiments will not be repeated.

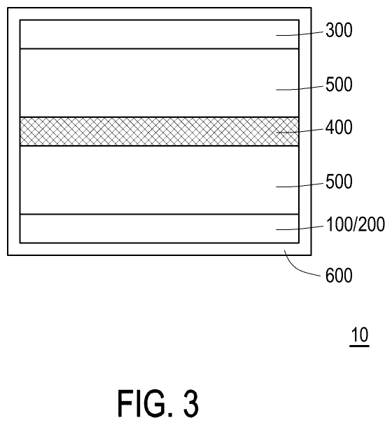

FIG. 3 is a schematic diagram of a metal battery according to an embodiment of the present disclosure. Referring to FIG. 3, the metal battery 10 includes the negative electrode 100 or the negative electrode 200, a separator 400, a positive electrode 300, and a liquid electrolyte 500. In one embodiment, the metal battery 10 may further include a packaging structure 600. In addition, in one embodiment, the metal battery 10 is a lithium metal battery.

According to one embodiment of the present disclosure, the positive electrode 300 may include a positive electrode active material. According to one embodiment of the present disclosure, the positive electrode active material includes elementary sulfur, organic sulfide, sulfur-carbon composite, metal-containing lithium oxide, metal-containing lithium sulfide, metal-containing lithium selenide, metal-containing lithium telluride, metal-containing lithium phosphide, metal-containing lithium silicide, metal-containing lithium boride, or a combination thereof, and the metal is at least one selected from the group consisting of aluminum, vanadium, titanium, chromium, copper, molybdenum, niobium, iron, nickel, cobalt, and manganese. According to one embodiment of the present disclosure, the positive electrode active material may include or be lithium-cobalt oxide (LiCoO₂), lithium-nickel oxide (LiNiO₂), lithium-manganese oxide (LiMn₂O₄), lithium-manganese-cobalt oxide (LiMnCoO₄), lithium-cobalt-nickel-manganese oxide (LiCo_{0.3}Ni_{0.3}Mn_{0.30}), lithium-cobalt phosphate (LiCoPO₄), lithium-manganese-chromium oxide (LiMnCrO₄), lithium-nickel-vanadium oxide (LiNiVO₄), lithium-manganese-nickel oxide (LiMn_{1.5}Ni_{0.5}O₄), lithium-cobalt-vanadium oxide (LiCoVO₄), or a combination thereof. In one embodiment, the positive electrode 300 may further include a conductive additive and a binder. The conductive additive and the binder may be conductive additives and binders commonly used in general batteries and are not particularly limited herein. For example, the conductive additive may include conductive carbon black, conductive graphite, fluorocarbon, reduced graphene, nitrogen-doped graphite, nitrogen-doped graphene, carbon fiber, carbon nanotube, or a combination thereof. For example, the binder may include a fluorine-containing polymer. The binder may include polyvinyl alcohol, polytetrafluoroethylene, sodium carboxymethyl cellulose, polyvinylidene fluoride, styrene-butadiene copolymer, fluorinated rubber, polyurethane, polyvinylpyrrolidone, poly(ethyl acrylate), polyvinyl chloride, polyacrylonitrile, polybutadiene, poly(acrylic acid), or a combination thereof. According to one embodiment of the present disclosure, the positive electrode 300 may further include a positive electrode substrate (not shown), and the positive electrode active material is disposed on or in the positive electrode substrate. In one embodiment, the positive electrode substrate is a positive electrode current-collecting substrate. According to one embodiment of the present disclosure, the positive electrode 300 is composed of a positive electrode active material, a conductive additive, a binder, and a positive electrode substrate. According to one embodiment of the present disclosure, the positive electrode 300 is composed of a positive electrode active material and a positive electrode substrate. According to one embodiment of the present disclosure, the positive electrode substrate may include a metal foil, such as a copper foil, an aluminum foil, a carbon-coated aluminum foil, a stainless steel foil, or other metal foils (such as platinum, titanium, etc.).

In one embodiment, as shown in FIG. 3, the negative electrode 100 or 200 is separated from the positive electrode 300 by the separator 400. The separator 400 may be a separator commonly used in general batteries and is not particularly limited here. According to one embodiment of the present disclosure, the separator 400 is made of insulating material, such as polyethylene (PE), polypropylene (PP), polytetrafluoroethylene film, polyamide film, polyvinyl chloride film, polyvinyl difluoride film, polyaniline film, polyimide film, polyethylene terephthalate, polystyrene (PS), cellulose, or a combination thereof. For example, the separator 400 may be a porous film of a PE/PP/PE multi-layer composite structure. According to one embodiment of the present disclosure, the thickness of the separator 400 is not particularly limited, and a person skilled in the art can adjust the thickness according to actual needs. For example, the thickness of the separator 400 may be about 1 μm to about 1,000 μm. (e.g., about 10 μm, 50 μm, 100 μm, 200 μm, 300 μm, 400 μm, 500 μm, 600 μm, 700 μm, 800 μm, or 900 μm). If the thickness of the separator 400 is too high (e.g., greater than 1,000 μm), the energy density of the battery is reduced. If the thickness of the separator 400 is too thin (e.g., less than 1 μm), the cycle stability of the battery is deteriorated.

In one embodiment, the liquid electrolyte 500 is disposed between the positive electrode 300 and the negative electrode 100 or 200. In one embodiment, as shown in FIG. 3, the stacked structure of the negative electrode 100 or 200, the separator 400 and the positive electrode 300 is immersed in a liquid electrolyte 500. In other words, the liquid electrolyte 500 is dispersed throughout the metal battery 10. As mentioned above, the protective layer 130 in the negative electrode 100 or 200 is a film layer formed after the liquid electrolyte 500 is decomposed, so although it is not shown in the figure, a person of ordinary skill in the field can understand that compared to the substrate 110 in the negative electrode 100 or 200, the protective layer 130 in the negative electrode 100 or 200 is close to the liquid electrolyte 500, and compared to the amorphous inorganic compound layer 132 in the protective layer 130, the organic compound layer 136 in the protective layer 130 is close to the liquid electrolyte 500.

According to one embodiment of the present disclosure, the liquid electrolyte 500 may include a solvent and a lithium salt. According to one embodiment of the present disclosure, the solvent may be an organic solvent, such as an ester solvent, a ketone solvent, a carbonate solvent, an ether solvent, an alkane solvent, an amide solvent, or a combination thereof. According to one embodiment of the present disclosure, the solvent includes a solvating solvent and a non-solvating solvent, wherein the solvating solvent can participate in dissolving the lithium salt, while the non-solvating solvent cannot participate in dissolving the lithium salt, so the non-solvating solvent may also be called a diluent. According to one embodiment of the present disclosure, the solvating solvent may be 1,2-dimethoxyethane (DME), dipropyl ether (DPE), 1,2-dimethoxypropane (DMP), 1,2-diethoxyethane (DEE), dimethoxymethane (DMM) or a combination thereof. According to one embodiment of the present disclosure, the non-solvating solvent may be 1,1,2,2-tetrafluoroethyl-2,2,3,3-tetrafluoropropyl ether (TTFE), 1,2-Bis(1,1,2,2-tetrafluoroethoxy)ethane (TFEE), tris(2,2,2-trifluoroethyl) orthoformate (TFEO), Bis(2,2,2-trifluoroethyl) ether (BTFE), 1H,1H,5H-octafluoropentyl 1,1,2,2-tetrafluoroethyl ether (OTE), or a combination thereof. In one embodiment, the molar ratio of the solvating solvent to the non-solvating solvent may be about 1:0.3 to 1:2.5.

According to one embodiment of the present disclosure, the concentration of the lithium salt may be greater than or equal to about 1.5 M. For example, the concentration of the lithium salt may be about 1.5 M to 2 M. According to one embodiment of the present disclosure, the lithium salt may be LiN(FSO₂)₂ (lithium bis(fluorosulfonyl)imide salt, LiFSI), LiN(SO₂CF₃)₂, LiN(SO₂CF₂CF₃)₂ or a combination thereof. In one embodiment, the molar ratio of the lithium salt to the solvating solvent may be about 1:1 to 1:4.

According to one embodiment of the present disclosure, there are a plurality of sub-micro encapsulated structures in the liquid electrolyte 500. Specifically, through the interaction of characteristics the compatibility of the solvating solvent and the non-solvating solvent, the solubility of the solvating solvent to the lithium salt, and the non-solvability of the non-solvating solvent to the lithium salt, the solvating solvent acts as a surfactant between the non-solvating solvent and the lithium salt which are immiscible in the liquid electrolyte 500, thereby, various aggregates composed of cations and anions generated by the dissociation of lithium salts are easily gathered inside the sub-micro encapsulated structure, while the non-solvating solvent is distributed around the sub-micro encapsulated structure. According to one embodiment of the present disclosure, the various aggregates in the sub-micro encapsulated structure include aggregates with a coordination number of 2 between a single cation and anions and aggregates with a coordination number of 3 or more between a single cation and anions. According to one embodiment of the present disclosure, aggregates with a coordination number of 3 or more between a single cation and anions tend to stay in the center of the sub-micro encapsulated structure, while aggregates with a coordination number of 2 between a single cation and anions tend to be located closer to the shell of the sub-micro encapsulated structure. According to one embodiment of the present disclosure, in the sub-micro encapsulated structure, the ratio of aggregates with a coordination number of 3 or more between a single cation and anions to aggregates with a coordination number of 2 between a single cation and anions is ≥1.

It is worth noting that the metal battery 10 includes any negative electrode (such as the negative electrode 100 or the negative electrode 200) proposed in the above embodiments, therefore, as mentioned above, the metal battery 10 can have good capacity, stability and battery cycle life.

Hereinafter, the features of the present disclosure will be described in more detail with reference to Examples 1 to 12 and Comparative Examples 1 to 10. Although the following Examples 1 to 12 are described, the materials used, the amount and ratio of each thereof, as well as the detailed process flow, etc. can be suitably modified without departing from the scope of this disclosure. Therefore, the scope of this disclosure should not be limited by the following embodiments.

### Evaluation of Corrosion Resistance of Protective Layer-Lithium-Copper Asymmetric Battery

### Example 1

Copper foil was used as the working electrode, lithium foil with a thickness of 200 μm was used as the reference electrode, and Celgard 2320 (PP/PE/PP) was used as a separator to separate the working electrode from the reference electrode. The separator was wetted with 75 μL of a liquid electrolyte including lithium salt LiFSI, a solvating solvent DME and a non-solvating solvent TTFE (the molar ratio of LiFSI, DME and TTFE is 1:1.2:3), and then a button-type battery CR2032 was formed after packaging.

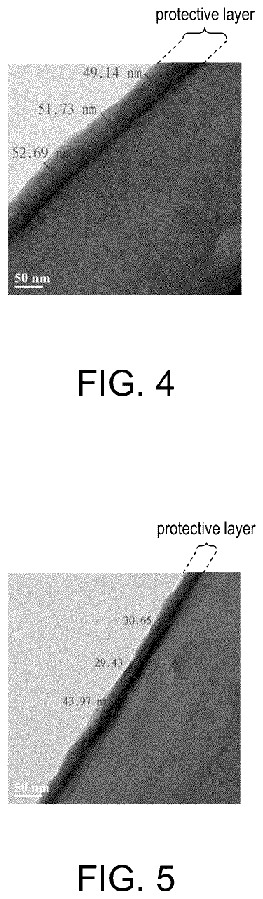

Next, the battery of Example 1 was charged once at a temperature of 60° C. with a constant current density of 0.2 mA/cm² to form the protective layer of Example 1 on the reference electrode. Next, cryogenic transmission electron microscopy (Cryo-TEM) was used to photograph the protective layer of Example 1, to obtain FIG. 4; and Gatan digital micrograph developed by Gatan Corporation of the United States was used to collect images of the crystalline lithium oxide particles in the protective layer of Example 1 and analyze the images to measure the particle size. Test method: an image of the sample to be tested was generated by using the transmission electron microscopy, and then the distance from the start to the end of the contour to be measured in the image was measured, which is the particle size of the sample to be tested. The measurement results are shown in Table 1 below.

### Example 2

The battery of Example 2 was prepared in the same manner as Example 1.

Next, the battery of Example 2 was charged once at a temperature of 60° C. with a constant current density of 0.2 mA/cm² to form the protective layer of Example 2 on the reference electrode. Next, after the battery having the protective layer of Example 2 was left to stand (i.e., without power supply) for 6 hours, the protective layer of Example 2 was photographed using cryo-TEM, to obtain FIG. 5; and Gatan digital micrograph developed by Gatan Corporation of the United States was also used to collect images of the crystalline lithium oxide particles in the protective layer of Example 2 and analyze the images to measure the particle size. The measurement results are shown in Table 1 below.

### Comparative Example 1

The battery of Comparative Example 1 was prepared in the same manner as Example 1.

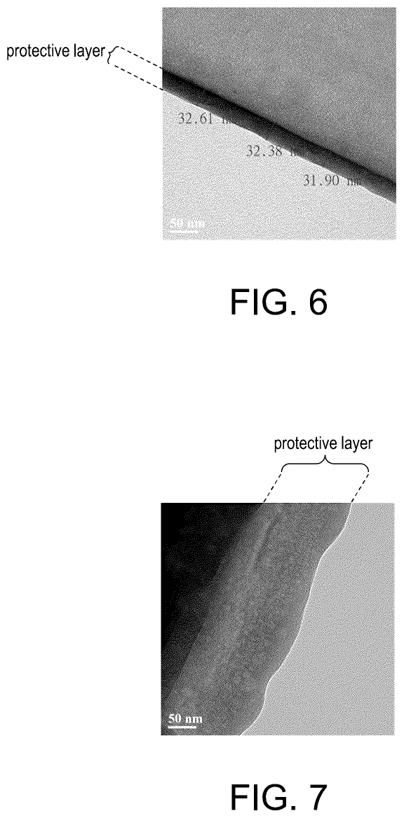

Next, the battery of Comparative Example 1 was charged once at room temperature (i.e., 25° C.) with a constant current density of 0.2 mA/cm² to form a protective layer of Comparative Example 1 on the reference electrode. The protective layer of Comparative Example 1 only includes the amorphous inorganic compound layer and the organic compound layer without forming crystalline lithium oxide particles. Next, the protective layer of Comparative Example 1 was photographed using Cryo-TEM to obtain FIG. 6.

### Comparative Example 2

The battery of Comparative Example 2 was prepared in the same manner as Example 1.

Next, the battery of Comparative Example 2 was charged once at room temperature (i.e., 25° C.) with a constant current density of 0.2 mA/cm² to form a protective layer of Comparative Example 2 on the reference electrode. The protective layer of Comparative Example 1 only includes the amorphous inorganic compound layer and the organic compound layer without forming crystalline lithium oxide particles. Next, after the battery having the protective layer of Comparative Example 2 formed thereon was left to stand (i.e, not powered) for 6 hours, the protective layer of Comparative Example 2 was photographed using Cryo-TEM to obtain FIG. 7.

TABLE 1

| | particle size (nm) |
|---|---|
| Example 1 | 6.1 |
| Example 2 | 6.1 |

The “particle size” in Table 1 refers to the average particle size of the crystalline lithium oxide particles in the amorphous inorganic compound layer.

FIG. 4 is a TEM image of the protective layer of Example 1. FIG. 5 is a TEM image of the protective layer of Example 2. FIG. 6 is a TEM image of the protective layer of Comparative Example 1. FIG. 7 is a TEM image of the protective layer of Comparative Example 2. It can be observed from FIG. 4 and FIG. 5 that the thickness of the protective layer of Example 2 after standing for 6 hours (average thickness: about 41 nm) is not much different from the thickness of the protective layer of Example 1 without standing (average thickness: about 49 nm), showing the protective layer with high stability. It can be observed from FIG. 6 and FIG. 7 that the thickness of the protective layer of Comparative Example 2 after standing for 6 hours (average thickness: about 30 nm) changed greatly compared to the thickness of the protective layer of Comparative Example 1 without standing (average thickness: about 56 nm), this is because the protective layer formed after charging does not contain crystalline lithium oxide particles, the effect of isolating the liquid electrolyte is weak, causing the interface between the protective layer and the electrode to be continuously corroded and thus the reaction continuously undergo, resulting in the continuous thickening of the protective layer. These results show that the protective layer comprising a plurality of crystalline lithium oxide particles dispersed in an amorphous inorganic compound layer disclosed in the present disclosure can enable the negative electrode of the battery to have good electrolyte corrosion resistance.

In addition, as can be seen from Table 1, the particle size of the crystalline lithium oxide particles of Example 2 after standing for 6 hours is almost unchanged compared with the particle size of the crystalline lithium oxide particles of Example 1 which has not been stood, indicating that the crystal stability is high. These results show that the protective layer comprising a plurality of crystalline lithium oxide particles dispersed in an amorphous inorganic compound layer disclosed in the present disclosure can enable the negative electrode of the battery to have good electrolyte corrosion resistance.

[symbol]

Cycle Life Test-Lithium-Copper Asymmetric Battery

[symbol]

### Example 3

The battery of Example 3 was prepared in the same manner as Example 1.

Next, the battery of Example 3 was charged and discharged three times at a temperature of 60° C. with a constant current density of 0.2 mA/cm 2 to complete the battery formation process and form the protective layer of Example 3 on the reference electrode, and the protective layer of Example 3 includes the crystalline lithium oxide particles dispersed in the amorphous inorganic compound layer. Next, the battery of Example 3 was subjected to charge and discharge cycle at room temperature (i.e., 25° C.) and at a constant current density of 0.5 mA/cm², and the number of cycles of the battery in Example 3 when an internal short circuit occurs was measured. The test results are shown in Table 2 below.

### Example 4

The battery of Example 4 was prepared in the same manner as Example 1.

Next, the battery of Example 4 was charged and discharged three times at a temperature of 60° C. with a constant current density of 0.4 mA/cm² to complete the battery formation process and form the protective layer of Example 4 on the reference electrode, and the protective layer of Example 4 includes the crystalline lithium oxide particles dispersed in the amorphous inorganic compound layer. Next, the battery of Example 4 was subjected to charge and discharge cycle at room temperature (i.e., 25° C.) at a constant current density of 0.5 mA/cm², and the number of cycles of the battery in Example 4 when an internal short circuit occurs was measured. The test results are shown in Table 2 below.

### Comparative Example 3

The battery of Comparative Example 3 was prepared in the same manner as in Example 1.

Next, the battery of Comparative Example 3 was charged and discharged three times at room temperature (i.e., 25° C.) with a constant current density of 0.2 mA/cm² to complete the battery formation process and form the protective layer of Comparative Example 3 on the reference electrode, and the protective layer of Comparative Example 3 only includes the amorphous inorganic compound layer and the organic compound layer without forming crystalline lithium oxide particles. Next, the battery of Comparative Example 3 was subjected to charge and discharge cycle at a constant current density of 0.5 mA/cm² and at room temperature (i.e., 25° C.), and the number of cycles of the battery of Comparative Example 3 when an internal short circuit occurs was measured. The test results are shown in Table 2 below.

### Comparative Example 4

The battery of Comparative Example 4 was prepared in the same manner as in Example 1.

Next, the battery of Comparative Example 4 was charged and discharged three times at room temperature (i.e., 25° C.) with a constant current density of 0.4 mA/cm² to complete the battery formation process and form the protective layer of Comparative Example 4 on the reference electrode, and the protective layer of Comparative Example 4 only includes the amorphous inorganic compound layer and the organic compound layer without forming crystalline lithium oxide particles. Next, the battery of Comparative Example 4 was subjected to charge and discharge cycle at a constant current density of 0.5 mA/cm² at room temperature (i.e., 25° C.), and the number of cycles of the battery of Comparative Example 4 when an internal short circuit occurs was measured. The test results are shown in Table 2 below.

TABLE 2

| | the number of cycles when an internal short |
|---|---|
| | circuit occurs |
| Example 3 | 157 |
| Example 4 | 124 |
| Comparative Example 3 | 58 |
| Comparative Example 4 | 77 |

It can be seen from Table 2 that the cycle life of the batteries of Example 3 and Example 4 is better than the cycle life of the batteries of Comparative Example 3 and Comparative Example 4. These results show that the protective layer comprising a plurality of crystalline lithium oxide particles dispersed in an amorphous inorganic compound layer disclosed herein can make the negative electrode of the battery have better stability, and thus the battery can have a good cycle life.

[symbol]

Aging Test-Lithium-Copper Asymmetric Battery

[symbol]

### Example 5

The battery of Example 5 was prepared in the same manner as Example 1.

Next, the battery of Example 5 was charged and discharged three times at a temperature of 60° C. with a constant current density of 0.2 mA/cm² to complete the battery formation process and form the protective layer of Example 5 on the reference electrode, and the protective layer of Example 5 includes the crystalline lithium oxide particles dispersed in the amorphous inorganic compound layer. Next, the battery of Example 5 was charged once at a temperature of 60° C. with a constant current density of 0.2 mA/cm², and then left to stand (i.e., without power supply) for 3 hours. Afterwards, the battery of Example 5 was discharged once at a temperature of 60° C. with a constant current density of 0.2 mA/cm² to a cut-off voltage of 1 V, and the first coulombic efficiency of the battery in Example 5 was measured. The test results are shown in Table 3 below.

### Example 6

The battery of Example 6 was prepared in the same manner as Example 1.

Next, the battery of Example 6 was charged and discharged three times at a temperature of 60° C. with a constant current density of 0.2 mA/cm² to complete the battery formation process and form the protective layer of Example 6 on the reference electrode, and the protective layer of Example 6 includes the crystalline lithium oxide particles dispersed in the amorphous inorganic compound layer. Next, the battery of Example 6 was charged once at a constant current density of 0.2 mA/cm² at a temperature of 60° C., and then left to stand (i.e, without power supply) for 6 hours. Afterwards, the battery of Example 6 was discharged once at a temperature of 60° C. with a constant current density of 0.2 mA/cm² to a cut-off voltage of 1 V, and the first coulombic efficiency of the battery of Example 6 was measured. The test results are shown in Table 3 below.

### Comparative Example 5

The battery of Comparative Example 5 was prepared in the same manner as in Example 1.

Next, the battery of Comparative Example 5 was charged and discharged three times at room temperature (i.e., 25° C.) with a constant current density of 0.2 mA/cm² to complete the battery formation process and form the protective layer of Comparative Example 5 on the reference electrode, and the protective layer of Comparative Example 5 only includes the amorphous inorganic compound layer and the organic compound layer without forming crystalline lithium oxide particles. Next, the battery of Comparative Example 5 was charged once at room temperature (i.e., 25° C.) with a constant current density of 0.2 mA/cm², and then left to stand (i.e., without power) for 3 hours. Afterwards, the battery of Comparative Example 5 was discharged once at room temperature (i.e., 25° C.) with a constant current density of 0.2 mA/cm² to a cut-off voltage of 1 V, and the first coulombic efficiency of the battery of Comparative Example 5 was measured. The test results are shown in Table 3 below.

### Comparative Example 6

The battery of Comparative Example 6 was prepared in the same manner as in Example 1.

Next, the battery of Comparative Example 6 was charged and discharged three times at room temperature (i.e., 25° C.) with a constant current density of 0.2 mA/cm² to complete the battery formation process and form the protective layer of Comparative Example 6 on the reference electrode, and the protective layer of Comparative Example 6 only includes the amorphous inorganic compound layer and the organic compound layer without forming crystalline lithium oxide particles. Next, the battery of Comparative Example 6 was charged once at room temperature (i.e., 25° C.) with a constant current density of 0.2 mA/cm², and then left to stand (i.e., without power) for 6 hours. Afterwards, the battery of Comparative Example 6 was discharged once at room temperature (i.e., 25° C.) with a constant current density of 0.2 mA/cm² to a cut-off voltage of 1 V, and the first coulombic efficiency of the battery of Comparative Example 6 was measured. The test results are shown in Table 3 below.

TABLE 3

| | first coulombic efficiency (%) |
|---|---|
| Example 5 | 92.8 |
| Example 6 | 86.3 |
| Comparative Example 5 | 82.5 |
| Comparative Example 6 | 48.0 |

It can be seen from Table 3 that even after being left to stand for a period of time, the batteries of Examples 5 and 6 still have good first coulombic efficiency. Furthermore, the first coulombic efficiencies of the batteries of Examples 5 and 6 are both better than those of Comparative Examples 5 and 6. These results show that the protective layer comprising a plurality of crystalline lithium oxide particles dispersed in an amorphous inorganic compound layer disclosed in the present disclosure can make the negative electrode of the battery have good electrolyte corrosion resistance and lithium utilization rate, so that the battery can have good stability.

[symbol]

Capacity Retention Test-Lithium Metal Battery

[symbol]

### Example 7

NMC622 (3.3 mAh/cm²) (purchased from Hunan Ruixiang) was used as the positive electrode active material, and aluminum foil (purchased from China Steel Aluminum) was used as the positive electrode current-collecting substrate. NMC622, conductive additives (carbon powder super-P, CNT) and binder (PVDF-HSV1800) were mixed evenly in a weight ratio of 96:1.4:0.6:2 to prepare electrode slurry, the slurry was then coated on aluminum foil and dried to form a positive electrode. A lithium foil with a thickness of 20 μm was used as the active material layer of the negative electrode, a copper foil (purchased from Bencheng Metal) was used as the current-collecting substrate of the negative electrode, and Celgard 2320 was used as a separator to separate the positive electrode from the negative electrode. After wetting the separator with 75 μL of a liquid electrolyte including lithium salt LiFSI, a solvating solvent DME and a non-solvating solvent TTFE (the molar ratio of LiFSI, DME and TTFE is 1:1.2:3), an aluminum-plastic film was used as a packaging structure for packaging to form a lithium metal battery of Example 7 (with an energy density of 350 Wh/kg).

Next, the lithium metal battery of Example 7 was subjected to a formation process to form the protective layer of Example 7 (including the crystalline lithium oxide particles dispersed in the amorphous inorganic compound layer) on the lithium foil. One formation charge and discharge cycle includes steps of: at a temperature of 45° C., charging to 4.4V at a current of 0.1C, stop charging when the constant voltage current is less than 0.01C, and then discharging to 3.0V at a current of 0.1C. After three formation charge and discharge cycles, the lithium metal battery of Example 7 was charged to 4.2V at a current of 0.1C at room temperature (i.e., 25° C.), and then discharged at a current of 0.1C to 3.0V to perform charge and discharge cycle measurement, and the capacitance retention rate and number of cycles were calculated. The test results are shown in Table 4.

### Example 8

NMC811 (4.1 mAh/cm²) (purchased from RONBAY Technology) was used as the positive electrode active material, and aluminum foil (purchased from China Steel Aluminum) was used as the positive electrode current-collecting substrate. NMC811, conductive additives (carbon powder super-P, CNT) and binder (PVDF-HSV1800) were mixed evenly in a weight ratio of 96:1.4:0.6:2 to prepare electrode slurry, the slurry was then coated on aluminum foil and dried to form a positive electrode. A copper foil (purchased from Bencheng Metal) was used as the current-collecting substrate of the negative electrode, and Celgard 2320 was used as a separator to separate the positive electrode from the negative electrode. After wetting the separator with 75 μL of a liquid electrolyte including lithium salt LiFSI, a solvating solvent DME and a non-solvating solvent TTFE (the molar ratio of LiFSI, DME and TTFE is 1:1.2:3), an aluminum-plastic film was used as a packaging structure for packaging to form a lithium metal battery of Example 8 (with an energy density of 400 Wh/kg).

Next, the lithium metal battery of Example 8 was subjected to a formation process to form the protective layer of Example 8 (including the crystalline lithium oxide particles dispersed in the amorphous inorganic compound layer) on the copper foil. One formation charge and discharge cycle includes steps of: at a temperature of 45° C., charging to 4.4V at a current of 0.1C, stop charging when the constant voltage current is less than 0.01C, and then discharging to 3.6V at a current of 0.1C. After three formation charge and discharge cycles, the lithium metal battery of Example 8 was charged to 4.3V at a current of 0.2C at room temperature (i.e., 25° C.), and then discharged at a current of 0.2C to 3.6V to perform charge and discharge cycle measurement, and the capacitance retention rate and the number of cycles were calculated. The test results are shown in Table 4 below.

### Example 9

The lithium metal battery of Example 9 (with an energy density of 400 Wh/kg) was prepared in the same manner as in Example 8.

Next, the lithium metal battery of Example 9 was subjected to a formation process to form the protective layer of Example 9 (including the crystalline lithium oxide particles dispersed in the amorphous inorganic compound layer) on the copper foil. One formation charge and discharge cycle includes steps of: at a temperature of 60° C., charging to 4.4V at a current of 0.1C, stop charging when the constant voltage current is less than 0.01C, and then discharging to 3.6V at a current of 0.1C. After three formation charge and discharge cycles, the lithium metal battery of Example 9 was charged to 4.3V at a current of 0.2C at room temperature (i.e., 25° C.), and then discharged to 3.6V at a current of 0.2C to perform charge and discharge cycle measurement, and the capacitance retention rate and number of cycles were calculated. The test results are shown in Table 4.

### Example 10

According to the preparation method of the lithium metal battery described in Example 8, except that a lithium foil with a thickness of 6.5 microns was used as the active material layer of the negative electrode to be formed on the copper foil (the current-collecting substrate of the negative electrode), to obtain the lithium metal battery of Example 10 (with an energy density of 400 Wh/kg).

Next, the lithium metal battery of Example 10 was subjected to a formation process to form the protective layer of Example 10 (including the crystalline lithium oxide particles dispersed in the amorphous inorganic compound layer) on the lithium foil. One formation charge and discharge cycle includes steps of: at a temperature of 60° C., charging at a current of 0.1C to 4.4V, stop charging when the constant voltage current is less than 0.01C, and then discharging at a current of 0.1C to 3.0V. After three formation charge and discharge cycles, the lithium metal battery of Example 10 was charged to 4.3V at a current of 0.2C at room temperature (i.e., 25° C.), and then discharged to 3.0V at a current of 0.2C to perform charge and discharge cycle measurement, and the capacitance retention rate and number of cycles were calculated. The test results are shown in Table 4.

### Example 11

According to the preparation method of the lithium metal battery described in Example 8, except that a lithium foil with a thickness of 20 microns was used as the active material layer of the negative electrode to be formed on the copper foil (the current-collecting substrate of the negative electrode), to obtain the lithium metal battery of Example 11 (with an energy density of 400 Wh/kg).

Next, the lithium metal battery of Example 11 was subjected to a formation process to form the protective layer of Example 11 (including the crystalline lithium oxide particles dispersed in the amorphous inorganic compound layer) on the lithium foil. One formation charge and discharge cycle includes steps of: at a temperature of 60° C., charging at a current of 0.05C to 4.4V, stop charging when the constant voltage current is less than 0.01C, and then discharging at a current of 0.05C to 3.0V. After three formation charge and discharge cycles, the lithium metal battery of Example 11 was charged to 4.3V at a current of 0.2C at room temperature (i.e., 25° C.), and then discharged at a current of 0.2C to 3.0V to perform charge and discharge cycle measurement, and the capacitance retention rate and the number of cycles were calculated. The test results are shown in Table 4 below.

### Example 12

The lithium metal battery of Example 12 (with an energy density of 400 Wh/kg) was prepared according to the same preparation method as Example 11.

Next, the lithium metal battery of Example 12 was subjected to a formation process to form the protective layer of Example 12 (including crystalline lithium oxide particles dispersed in the amorphous inorganic compound layer) on the lithium foil. One formation charge and discharge cycle includes steps of: at a temperature of 60° C., charging at a current of 0.1C to 4.4V, stop charging when the constant voltage current is less than 0.01C, and then discharging at a current of 0.1C to 3.0V. After three formation charge and discharge cycles, the lithium metal battery of Example 12 was charged to 4.3V at a current of 0.2C at room temperature (i.e., 25° C.), and then discharged at a current of 0.2C to 3.0V to perform charge and discharge cycle measurement, and the capacitance retention rate and the number of cycles were calculated. The test results are shown in Table 4 below.

### Comparative Example 7

The lithium metal battery of Comparative Example 7 (with an energy density of 350 Wh/kg) was prepared in the same manner as in Example 7.

Next, the lithium metal battery of Comparative Example 7 was subjected to a formation process to form a protective layer of Comparative Example 7 (without the formation of crystalline lithium oxide particles) on the lithium foil. One formation charge and discharge cycle includes steps of: at room temperature (i.e., 25° C.), charging at a current of 0.1C to 4.4V, stop charging when the constant voltage current is less than 0.01C, and then discharging at a current of 0.1C to 3.0V. After three formation charge and discharge cycles, the lithium metal battery of Comparative Example 7 was charged to 4.2V at a current of 0.1C at room temperature (i.e., 25° C.), and then discharged at a current of 0.1C to 3.0V to perform charge and discharge cycle measurement, and the capacitance retention rate and the number of cycles were calculated. The test results are shown in Table 4 below.

### Comparative Example 8

The lithium metal battery of Comparative Example 8 (with an energy density of 400 Wh/kg) was prepared in the same manner as in Example 8.

Next, the lithium metal battery of Comparative Example 8 was subjected to a formation process to form a protective layer of Comparative Example 8 (without the formation of crystalline lithium oxide particles) on the copper foil. One formation charge and discharge cycle includes steps of: at room temperature (i.e., 25° C.), charging at a current of 0.1C to 4.4V, stop charging when the constant voltage current is less than 0.01C, and then discharging at a current of 0.1C to 3.6V. After three formation charge and discharge cycles, the lithium metal battery of Comparative Example 8 was charged to 4.3V at a current of 0.2C at room temperature (i.e., 25° C.), and then discharged at a current of 0.2C to 3.6V to perform charge and discharge cycle measurement, and the capacitance retention rate and the number of cycles were calculated. The test results are shown in Table 4 below.

### Comparative Example 9

The lithium metal battery of Comparative Example 9 (with an energy density of 400 Wh/kg) was prepared in the same manner as in Example 10.

Next, the lithium metal battery of Comparative Example 9 was subjected to a formation process to form a protective layer of Comparative Example 9 on the lithium foil (without the formation of crystalline lithium oxide particles). One formation charge and discharge cycle includes steps of: at room temperature (i.e. 25° C.), charging to 4.4V at a current of 0.1C until the constant voltage current is less than 0.01C and then stop charging, then discharging to 3.0V with a current of 0.1C. After three formation charge and discharge cycles, the lithium metal battery of Comparative Example 9 was charged to 4.3V at a current of 0.2C at room temperature (i.e., 25° C.), and then discharged at a current of 0.2C to 3.0V to perform charge and discharge cycle measurement, and the capacitance retention rate and the number of cycles were calculated. The test results are shown in Table 4 below.

### Comparative Example 10

The lithium metal battery of Comparative Example 10 (with an energy density of 400 Wh/kg) was prepared in the same manner as in Example 11.

Next, the lithium metal battery of Comparative Example 10 was subjected to a formation process to form a protective layer of Comparative Example 10 on the lithium foil (without the formation of crystalline lithium oxide particles). One formation charge and discharge cycle includes steps of: at room temperature (i.e. 25° C.), charging to 4.4V at a current of 0.1C until the constant voltage current is less than 0.01C and then stop charging, then discharging to 3.0V with a current of 0.1C. After three formation charge and discharge cycles, the lithium metal battery of Comparative Example 10 was charged to 4.3V at a current of 0.2C at room temperature (i.e., 25° C.), and then discharged at a current of 0.2C to 3.0V to perform charge and discharge cycle measurement, and the capacitance retention rate and the number of cycles were calculated. The test results are shown in Table 4 below.

TABLE 4

| | capacitance retention rate (%)/number of cycles |
|---|---|
| Example 7 | 90%/710 |
| Example 8 | 80%/219 |
| Example 9 | 80%/305 |
| Example 10 | 80%/146 |
| Example 11 | 90%/384 |
| Example 12 | 90%/350 |
| Comparative Example 7 | 80%/698 |
| Comparative Example 8 | 80%/103 |
| Comparative Example 9 | 80%/51 |
| Comparative Example 10 | 90%/309 |

It can be seen from Table 4 that compared with the lithium metal battery of Example 7, of which the capacitance retention rate is still 90% when the number of charge and discharge cycles reaches 710, the capacitance retention rate of the lithium metal battery of Comparative Example 7 has dropped to 80% when the number of charge and discharge cycles reaches 698, indicating that since the negative electrode of Comparative Example 7 does not have the crystalline lithium oxide particles described in the present disclosure, the stability of the protective layer is poor, resulting in a significantly faster battery electrical degradation. In addition, it can be seen from Table 4 that compared with the lithium metal batteries of Example 8 and Example 9, of which the capacitance retention rates drop to 80% when the numbers of charge and discharge cycles reach 219 and 305 respectively, the capacitance retention rate of the lithium metal battery of Comparative Example 8 has dropped to 80% when the number of charge and discharge cycles is only 103, indicating that since the negative electrode of Comparative Example 8 does not have the crystalline lithium oxide particles described in the present disclosure, the stability of the protective layer is poor, resulting in a significantly faster battery electrical degradation. In addition, it can be seen from Table 4 that compared with the lithium metal battery of Example 10, of which the capacitance retention rate drops to 80% when the number of charge and discharge cycles reaches 146, the capacitance retention rate of the lithium metal battery of Comparative Example 9 has dropped to 80% when the number of charge and discharge cycles is only 51, indicating that since the negative electrode of Comparative Example 9 does not have the crystalline lithium oxide particles described in the present disclosure, the stability of the protective layer is poor, resulting in a significantly faster battery electrical degradation. In addition, it can be seen from Table 4 that compared with the lithium metal batteries of Example 11 and Example 12, of which the capacitance retention rate are 90% when the numbers of charge and discharge cycles reach 384 and 350 respectively, the capacitance retention rate of the lithium metal battery of Comparative Example 10 has dropped to 90% when the number of charge and discharge cycles of is only 309, indicating that since the negative electrode of Comparative Example 10 does not have the crystalline lithium oxide particles described in the present disclosure, the stability of the protective layer is poor, resulting in a significantly faster battery electrical degradation. These results show that the protective layer disclosed in the present disclosure includes a plurality of crystalline lithium oxide particles dispersed in an amorphous inorganic compound layer, it can make the negative electrode of the lithium metal battery have good electrolyte corrosion resistance and lithium utilization rate, so that the lithium metal battery can have good cycle life and stability.

In summary, the negative electrode including the protective layer with a specific structure and composition disclosed in the present disclosure has good electrolyte corrosion resistance and lithium utilization rate, and is suitable for metal batteries. As a result, the metal battery including the negative electrode can have good cycle life, capacity and stability.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A negative electrode, comprising:
a substrate; and
a protective layer disposed on the substrate, wherein the protective layer comprises:
an amorphous inorganic compound layer; and
a plurality of crystalline lithium oxide particles dispersed in the amorphous inorganic compound layer.

2. The negative electrode as claimed in claim 1, wherein a particle size of the plurality of crystalline lithium oxide particles is about 1 nm to about 100 nm.

3. The negative electrode as claimed in claim 1, wherein the plurality of crystalline lithium oxide particles have a crystal plane (111), a crystal plane (220), a crystal plane (311), a crystal plane (400), a crystal plane (422), a crystal plane (440) or a combination thereof.

4. The negative electrode as claimed in claim 1, wherein the plurality of crystalline lithium oxide particles are dispersed at a side of the amorphous inorganic compound layer away from the substrate.

5. The negative electrode as claimed in claim 1, wherein the amorphous inorganic compound layer includes lithium oxide accounting for 90 wt % or more of a total weight of the amorphous inorganic compound layer.

6. The negative electrode as claimed in claim 1, wherein a thickness of the protective layer is greater than 10 nm.

7. The negative electrode as claimed in claim 1, wherein the protective layer further comprises: an organic compound layer disposed on the amorphous inorganic compound layer.

8. The negative electrode as claimed in claim 7, wherein the organic compound layer includes an oligomer.

9. The negative electrode as claimed in claim 1, further comprising: an active material layer disposed between the substrate and the protective layer, wherein the active material layer comprises lithium metal, a lithium-containing alloy, or a combination thereof.

10. A metal battery, comprising:
a positive electrode;
a separator;
a negative electrode, separated from the positive electrode by the separator, wherein the negative electrode is the negative electrode as claimed in claim 1; and
a liquid electrolyte disposed between the positive electrode and the negative electrode.

11. The metal battery as claimed in claim 10, further comprising a packaging structure wrapping the positive electrode, the separator, the negative electrode and the liquid electrolyte.
